(19) United States
(12) Patent Application Publication
(10) Pub. No.: US 2010/0213642 A1
(43) Pub. Date: Aug. 26, 2010

(54) RESIN STAMPER MOLDING DIE AND METHOD FOR MANUFACTURING RESIN STAMPER USING THE SAME

(75) Inventors: Yasuaki Ootera, Yokohama-shi (JP); Shinobu Sugimura, Yokohama-shi (JP); Seiji Morita, Yokohama-shi (JP); Masatoshi Sakurai, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/709,331

(22) Filed: Feb. 19, 2010

(30) Foreign Application Priority Data
Feb. 20, 2009 (JP) 2009-038205

(51) Int. Cl. B29C 59/16; B29C 45/14

(52) U.S. Cl. 264/447; 425/542

(57) ABSTRACT

According to one embodiment, the present invention provides a resin stamper injection molding die including a fixed side template having a metal stamper mounting surface mirror-ground in a random direction, a metal stamper having a front surface with recesses and protrusions and a back surface mirror-ground in a random direction, and a moving side template. The metal stamper has a surface roughness of 0 to 50 nm. The metal stamper mounting surface has a surface roughness of 0 to 1.0 nm, and has a coefficient of static friction of at most 0.20 with respect to the second main surface of the metal stamper.

### CROSS-REFERENCE TO RELATED APPLICATIONS

This application is based upon and claims the benefit of priority from Japanese Patent Application No. 2009-038205, filed Feb. 20, 2009, the entire contents of which are incorporated herein by reference.

### BACKGROUND

1. Field

One embodiment of the present invention relates to a metal stamper used to manufacture a magnetic recording medium having discrete tracks on the surface of a magnetic recording layer, a stamper molding die, and a method for manufacturing the stamper.

2. Description of the Related Art

In recent years, to improve the medium recording density of hard disk drives, which are magnetic recording devices, discrete track recording media (DTR media) in which recording tracks are physically separated from one another have been proposed.

In such a proposal, grooves are formed in the surface of the discrete track recording medium to form separated tracks, thus increasing the recording density in a track direction. In the medium, not only the grooves can each be formed between the tracks but also a servo pattern can be carved in the form of recesses and protrusions. Thus, improved patterning eliminates the need to record servo signals in each medium as in the conventional art, thus improving productivity.

For example, as disclosed in Jpn. Pat. Appln. KOKAI Publication No. 2003-157520, during the manufacture of the DTR medium, an imprint stamper is pressed against a resist applied to the surface of a magnetic recording layer to transfer a recess and protrusion pattern to the resist. Moreover, the magnetic recording layer is processed through the resist as a mask.

However, the servo pattern formed on the DTR medium has a track pitch and a recess and protrusion height both of at most 100 nm. Furthermore, the resist applied to a magnetic layer deposited on a medium substrate has a reduced thickness of at most 10 nm. However, when the imprint stamper is pressed against the resist on the medium substrate, for example, a pattern on the back surface of a metal stamper and a pattern on a surface of a die on which the metal stamper is installed may be transferred to a resin stamper during injection molding. This may disadvantageously distort the servo pattern.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic diagram showing the configuration of a resin stamper molding die according to the present invention;

FIG. 2 is a diagram showing a process of forming a magnetic recording medium with discrete tracks;

FIG. 3 is a diagram showing a process of manufacturing a metal stamper;

FIG. 4 is a diagram of the measured distortion of a pattern on a resin stamper;

FIG. 5 is a diagram of the measured distortion of the pattern on the resin stamper; and

FIG. 6 is a diagram of the measured distortion of the pattern on the resin stamper.

### DETAILED DESCRIPTION

Various embodiments according to the invention will be described hereinafter with reference to the accompanying drawings. In general, according to,one embodiment of the invention, a resin stamper injection molding die comprises a fixed side template having a metal stamper mounting surface, a metal stamper having a first main surface with a recess and protrusion shape corresponding to a discrete track pattern and a smooth, different principal surface, the metal stamper being placed with the second main surface in contact with the metal stamper mounting surface, and a moving side template located opposite the fixed side template via the metal stamper.

The resin stamper injection molding die is characterized in that the metal stamper is mirror-ground in a random direction and has a surface roughness of 0 to 50 nm, and the metal stamper mounting surface is mirror-ground in a random direction, has a surface roughness of 0 to 1.0 nm, and has a coefficient of static friction of at most 0.20 with respect to the second main surface of the metal stamper.

A method for manufacturing a resin stamper according to the present invention uses the resin stamper injection molding die and is characterized in that the resin stamper is molded by injecting an injection molding resin material into a cavity between the metal stamper and the moving side template and then pressurizing and cooling the injection molding resin material.

According to the present invention, the smooth surface of the metal stamper and the metal stamper mounting surface of the die are mirror-ground, and the coefficient of static friction can be reduced. Thus, with tracks prevented from being distorted by imprinting with roughening or a scratch of the smooth surface of the metal stamper and the metal stamper mounting surface of the die, appropriate slippage can be allowed to occur between the smooth surface of the metal stamper and the metal stamper mounting surface. This allows absorption of a possible dimensional expansion difference caused by a substantial temperature difference between the die and the metal stamper in a cooling process during molding of the resin stamper. Possible local track distortion can thus be prevented. The appropriate slippage absorbing the possible dimensional expansion difference is effective for increasing the lifetime of the metal stamper and the die.

Moreover, optionally coating the metal stamper mounting surface of the die with diamond-like carbon (DLC) allows the value of the coefficient of static friction to be changed from at most 0.20 to, for example, 0.03 to 0.20.

Now, with reference to the drawings, the present invention will be described in further detail.

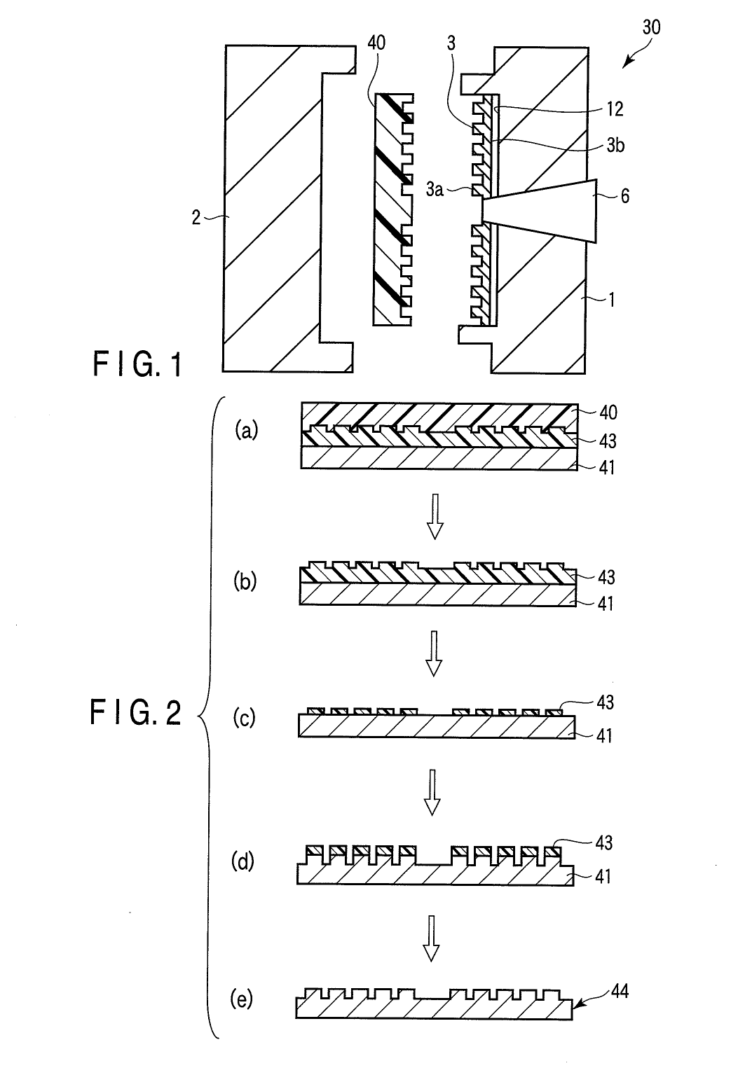

FIG. 1 is a schematic diagram showing the configuration of a resin stamper molding die according to the present invention.

As shown in FIG. 1, the resin stamper molding die 30 has a fixed side template 1 including a metal stamper mounting surface 12 mirror-ground in a random direction, a metal stamper 3, and a moving side template 2 located opposite the fixed side template 1 via the metal stamper 3. The metal stamper 3 has a first main surface 3 a with, for example, spiral or concentric discrete tracks and a recess and protrusion shape corresponding to a servo shape, and a second main surface 3 b mirror-ground in a random direction. The second main surface is placed in contact with the metal stamper mounting surface 12. Reference number 40 denotes a schematically shown disk-like resin stamper injection-molded using the die 30.

Here, the metal stamper 3 has a surface roughness of at most 50 nm. The metal stamper mounting surface 12 has a surface roughness of 0 to 1.0 nm and a coefficient of static friction of at most 0.20 with respect to the second main surface 3b of the metal stamper 3.

FIG. 2 is a sectional view showing a process of forming a magnetic recording medium with discrete tracks using a resin stamper obtained from the die shown in FIG. 1.

To allow a magnetic recording medium to be formed using a resin stamper, injection molding is performed using the die in FIG. 1, to obtain the resin stamper 40. First, metal having discrete tracks and a recess and protrusion pattern 3a corresponding to a servo pattern, for example, the Ni stamper 3, is placed on the fixed side template 1 so that the recess and protrusion pattern 3a faces the moving side template 2. The fixed side template 1 and the moving side template 2 are then laid on top of each other. A molten injection molding resin is injected into the cavity between the fixed side template 1 and the moving side template 2 through an injection hole 6 in the fixed side template 1 which leads to a central portion thereof. Subsequently, injection molding is performed by pressurizing the die by means of clamping and then cooling the die. The central portion of the molded article is punched using a cut punch (not shown in the drawings) to obtain the disc-like resin stamper 40 having the central hole. The tracks and the recesses and protrusions making up the servo pattern are carved into the surface 3a of the metal stamper 3. Thus, the tracks and the recesses and protrusions making up the servo pattern are transferred to the resin stamper 40 molded using the metal stamper 3 as a die. For example, a cycloolefin polymer, carbonate, or acrylic may be used as an injection molding resin material.

Then, as shown in FIG. 2(a), an ultraviolet-curable resin 43 is applied to the surface of the magnetic recording medium 41. The resin stamper 40 is then pressed against the ultraviolet-curable resin 43. The resulting structure is irradiated with ultraviolet rays for curing (UV imprinting).

Subsequently, as shown in FIG. 2(b), the resin stamper 40 is peeled off from the ultraviolet-curable resin. The resin stamper is peeled off to expose an ultraviolet-curable resin layer to which the tracks and the recesses and protrusions making up the servo pattern have been transferred.

Thereafter, as shown in FIG. 2(c), residues of the ultraviolet-curable resin 43 are removed from the recess portions of the pattern by dry etching with, for example, gaseous CF₄ or O₂. A bottom-out operation is then performed until the surface of the magnetic recording medium 41 is exposed in the recess portions of the recess and protrusion pattern.

Moreover, as shown in FIG. 2(d), the surface of the magnetic recording medium 41 is processed by, for example, Ar ion milling through the ultraviolet-curable resin 43 as a mask. Thus, the tracks and the recesses and protrusions of the servo pattern are formed on the surface of the magnetic recording medium 41. The surface of the magnetic recording medium 41 is processed by ion milling.

Thereafter, as shown in FIG. 2(e), the ultraviolet-curable resin 43 is removed by dry etching to obtain a discrete track magnetic recording medium 44.

The magnetic recording medium obtained may be subjected to a postprocess such as burial of a nonmagnetic substance in the recess portions of the pattern, application of a lubricant, or tape grinding.

The magnetic recording medium dealt with in the present specification is 1.8 inches in size, and has, for example, a diameter of 48±0.2 mm, a central hole diameter of 12.01±0.01 mm, and a thickness of 0.508±0.05 mm. However, a 2.5-inch medium (diameter 65±0.2 mm, central hole diameter 20.01±0.01 mm, thickness 0.635±0.05 mm) may be used instead.

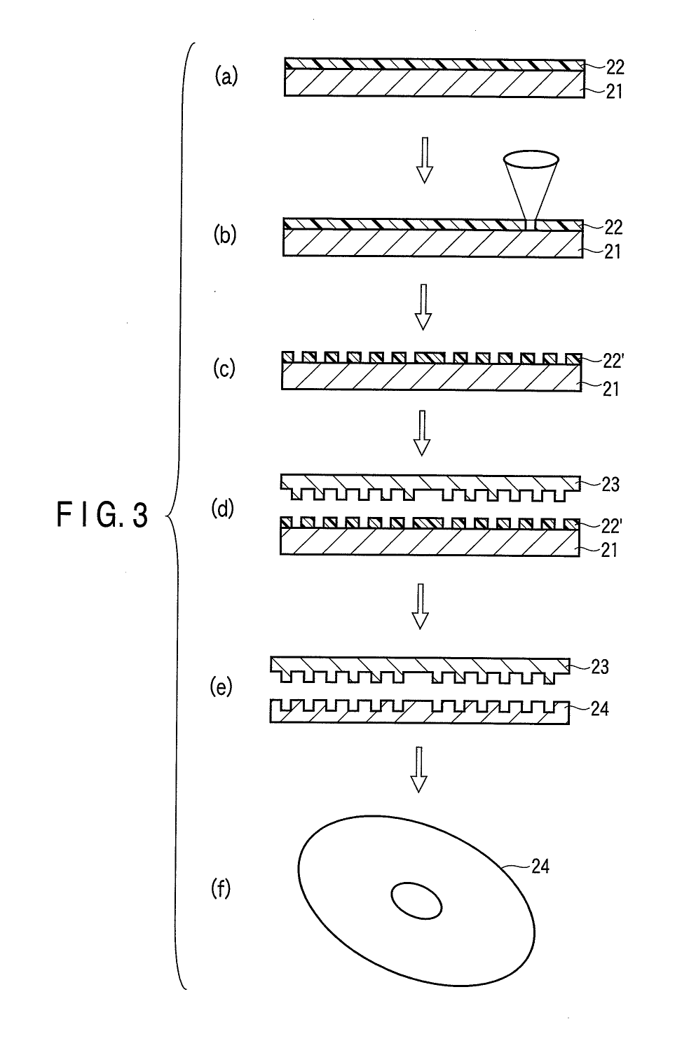

FIG. 3 is a diagram showing a process of manufacturing a metal stamper.

As shown in FIG. 3(a), first, an electron beam resist is applied to an Si wafer.

Then, as shown in FIG. 3(b), the electron beam resist is exposed to electron beams to allow tracks and a servo pattern to be formed.

Subsequently, as shown in FIG. 3(c), the electron beam resist is developed to melt an exposed portion or an unexposed portion to form the tracks and recesses and protrusions 22′ of the servo pattern.

Moreover, as shown in FIG. 3(d), the recesses and protrusions 22′ on the electron beam resist are made electrically conductive and plated with Ni. The pattern is thus duplicated with Ni to produce an Ni father stamper 23.

Thereafter, the Ni father stamper 23 is plated with Ni to produce an Ni mother stamper 24.

A sun stamper or a daughter stamper may be produced as required.

Moreover, as shown in FIG. 3(f), the back surface of the Ni mother stamper 24 is ground to process the central hole and outer periphery of the Ni mother stamper 24. The Ni mother stamper 24 is thus shaped like a donut so as to be mounted in an injection molding die.

In the manufacture of the discrete track magnetic recording medium using the imprint method as described above, distortion of the transferred pattern is a major problem. If the tracks are distorted and the shape of the tracks deviates from roundness, the servo positioning accuracy of the hard disk medium may decrease even if the magnitude of the deviation is about several hundred nm. This may compromise the advantage of the discrete magnetic recording medium that the servo pattern can be formed simultaneously with the tracks.

A possible cause of the distortion of the pattern is that the pattern on the back surface of the metal stamper is transferred to the resin stamper molded during the injection molding.

The injection molding metal stamper generally has a thickness of about 300 μm. Thus, during the molding of the resin stamper, nano order patterns cannot be transferred unless a clamping pressure of about 40 to 60 t is not applied to the metal stamper. This may result in a phenomenon in which the manner in which the back surface of the metal stamper is finished, for example, a mirror surface or a rough surface or the presence of a scratch is transferred to the resin stamper in the form of a relief, that is, what is called back transfer. The relief may distort the tracks.

Thus, the back surface of the metal stamper is desirably mirror-finished if possible. For example, mirror grinding may be performed using slurry containing cerium oxide or the like. Moreover, also to prevent the shape of the tracks from deviating from roundness as a result of distortion, the grinding trace of the mirror grinding desirably extends in a random direction rather than in one direction. The surface roughness of the back surface is 0 to 50 nm, more desirably 0 to 6 nm. This enables roughening of the back surface of the metal stamper or distortion of the tracks caused by a scratch to be inhibited.

In this case, the relief or scratch on the back surface may be transferred to the resin stamper because of the metal stamper mounting surface of the die. Thus, the metal stamper mounting surface may be mirror-finished. In general, the material of the die is stainless steel (for example, STAVAX). Areas that may be worn away, such as the metal stamper mounting surface, are coated with TiN. In the present invention, the metal stamper mounting surface of the die is mirror-finished by being mirror-ground with, for example, diamond paste before coating. When the metal stamper mounting surface of the die is thus finished so as to have a surface roughness (Ra) of at most 1 nm, the possible distortion of the tracks can be inhibited which may be caused by roughening of the back surface of the metal stamper or a scratch on the back surface.

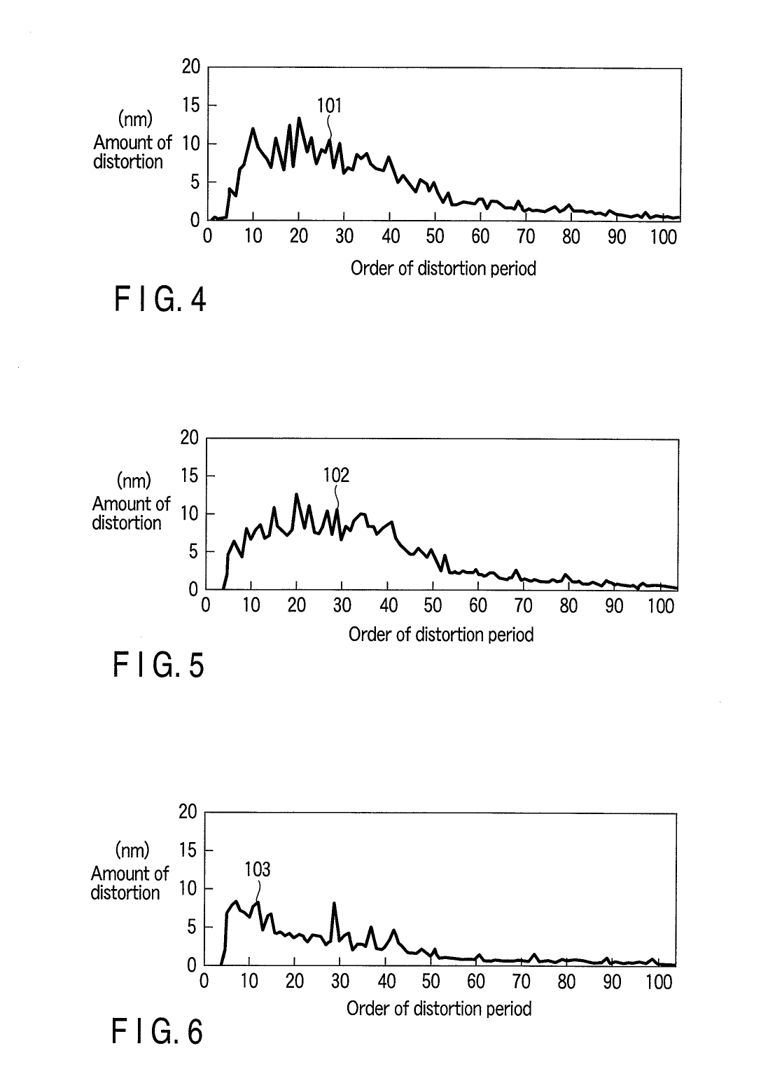

FIGS. 4 to 6 are graphs showing the results of measurement of the pattern distortion of the molded resin stamper with the level of grinding varied.

Reference number 101 in FIG. 4 shows a case in which the back surface of the Ni stamper has a surface roughness Ra of 51 nm and the stamper mounting surface of the die has a surface roughness Ra of 1 nm. Reference number 102 in FIG. 5 shows a case in which the back surface of the Ni stamper has a surface roughness Ra of 50 nm and the stamper mounting surface of the die has a surface roughness Ra of 2 nm. Reference number 103 in FIG. 6 shows a case in which the back surface of the Ni stamper has a surface roughness Ra of 50 nm and the stamper mounting surface of the die has a surface roughness Ra of 1 nm.

In each of the cases, the surface roughness Ra was measured using an atomic force microscope manufactured by Digital Instruments Corporation.

In the figures, the abscissa represents the order of a period corresponding to one rotation of a disc and in which distortion occurred. The ordinate represents the amount of distortion (nm).

For the magnetic recording medium, the possible distortion of the pattern (in this case, a servo signal) needs to be at most 10 nm at each order of the period. Thus, only FIG. 6 meets this requirement. That is, in the present invention, the back surface of the Ni stamper has a surface roughness Ra of at most 50 nm. The stamper mounting surface of the die has a surface roughness Ra of at most 1 nm.

When the coefficient of static friction between the back surface of the metal stamper and the metal stamper mounting surface is larger than 0.20, where the mirror-ground metals are in contact with each other, appropriate slippage tends to be prevented from occurring between the back surface of the metal stamper and the metal stamper mounting surface. In injection molding of, for example, the resin stamper, when the molding material is a cycloolefin polymer (for example, Zeonor), the temperature of the die is between about 75° C. and 95° C. On the other hand, the melting temperature of the molding resin is between about 350° C. and 380° C. Thus, a dimensional expansion difference is caused by the substantial difference in temperature between the die and the metal stamper during a resin cooling process. Without the appropriate slippage, the metal stamper may stick to the surface of the die, preventing the dimensional expansion difference from being absorbed. For example, dimensional distortion may concentrate locally in an area where the metal stamper sticks weakly to the surface of the die. This may increase the track distortion.

Thus, the present invention mirror-grinds the smooth surface of the metal stamper and the metal stamper surface of the die, and allows a reduction in coefficient of static friction. This prevents the track distortion from being caused by roughening of the surface or a scratch, while allowing appropriate slippage to occur between the smooth surface of the metal stamper and the metal stamper mounting surface. Thus, a possible dimensional expansion difference can be absorbed which is caused by a substantial difference in temperature between the die and the metal stamper in the cooling process during the molding of the resin stamper. Possible local track distortion can thus be prevented. The appropriate slippage absorbing the possible dimensional expansion difference is effective for increasing the lifetime of the metal stamper and the die.

The metal stamper mounting surface of the die may be coated with diamond-like carbon (DLC) in order to reduce the coefficient of static friction.

Three types of dies were prepared the metal stamper mounting surface of which was made up of stainless steel (STAVAX) having a surface roughness of 0 to 1.0 nm and mirror-ground in a random direction; in a first type, the metal stamper mounting surface was uncoated, in a second type, the metal stamper mounting surface was coated with TiN, and in a third type, the metal stamper mounting surface was coated with DLC. The coefficient of static friction between each of the metal stamper mounting surfaces and the back surface of the metal stamper was measured: the back surface was mirror-ground in a random direction and had a surface roughness Ra of at most 50 nm. For comparison, the coefficient of static friction between each of the metal stamper mounting surfaces and a rough metal stamper back surface was measured: the back surface was ground with a tape and had a surface roughness Ra of more than 50 nm. The results are shown in Table 1.

TABLE 1

| Back surface of | Static friction coefficient | | |
|---|---|---|---|
| metal stamper | No coating | TiN | DLC |
| Tape polishing | 0.18 | 0.14 | 0.03 |
| Mirror grinding | 0.31 | 0.25 | 0.06 |

As shown in the table, for the exposed stainless steel (STAVAX) and TiN coating as in the conventional art, the mirrored back surface of the metal stamper resulted in large coefficients of static friction of 0.31 and 0.25. That is, the metal stamper stuck to the metal stamper mounting surface. On the other hand, the metal stamper mounting surface coated with DLC according to the present invention resulted in a reduced coefficient of static friction of 0.06. The metal stamper and the metal stamper mounting surface were prevented from sticking to each other.

When the back surface of the metal stamper was finished by, for example, tape grinding as in the conventional art so as to have a surface roughness Ra of about at least 50 nm, the coefficient of static friction was small for all the dies, that is, 0.18 for the stainless steel, 0.14 for the TiN coated die, and 0.03 for the DLC coated die. The metal stamper and the metal stamper mounting surface were prevented from sticking to each other. However, when the resin stamper was injection-molded, the back surface of the metal stamper was transferred to the resin stamper, causing the tracks in the discrete magnetic recording medium to be distorted.

Furthermore, for the same DLC coating, the coefficient of static friction varies depending on deposition conditions (sputter pressure or voltage, the temperature during deposition, and the roughness of an underlying surface).

The surface of the die, serving as a deposition underlying surface, was ground using a diamond paste with a particle size of 0.3 μm. The metal stamper mounting surface was then coated with DLC with a deposition time set to 120 minutes so that the resulting coefficient of static friction was 0.21. Similarly, the surface of the die, serving as a deposition underlying surface, was ground using a diamond paste with a particle size of 0.3 μm. The metal stamper mounting surface was then coated with DLC with a deposition time set to 180 minutes so that the resulting coefficient of static friction was 0.20. A cycloolefin polymer (Zeonor 106OR) as a material was injection-molded using an Ni stamper with a mirrored back surface. A resin stamper was thus manufactured. The surface of the resin stamper obtained was observed using an optical microscope. Then, a molded article obtained using the metal stamper and die offering a coefficient of static friction of 0.21 exhibited sticking unevenness. On the other hand, a molded article obtained using the metal stamper and die offering a coefficient of static friction of 0.20 did not exhibit sticking unevenness. This indicates that the coefficient of static friction needs to be at most 0.20 in order to prevent possible sticking unevenness.

Thus, the present invention can solve the following problem. The ground condition of the back surface of the metal stamper may be transferred to the resin stamper, which is a molded article, to form a relief on the resin stamper. Tracks on the discrete magnetic recording medium which are obtained by UV-imprinting the position of the relief may be distorted such that the shape of the tracks deviates from roundness. This may disadvantageously reduce the servo positioning accuracy or the like. To prevent the problem, the present invention mirror-grinds the back surface of the metal stamper so that the grinding trace extends in a random direction and so that the surface roughness Ra is at most 50 nm, desirably at most 6 nm. At the same time, the metal stamper mounting surface of the die needs to be mirror-ground so that the grinding trace extends in a random direction and so that the surface roughness Ra is at most 1.0 nm. In this case, the coefficient of static friction between the metal stamper and the surface of the die may increase to cause the metal stamper to stick to the metal stamper mounting surface. This may locally distort the tracks. The present invention can avoid this phenomenon by coating the surface of the die with DLC to reduce the coefficient of static friction to at most 0.2.

The present invention can prevent the tracks on the finally manufactured discrete magnetic recording medium from being distorted such that the shape of the tracks deviates from roundness. The present invention can thus avoid a possible disadvantageous decrease in servo positioning accuracy or the like.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A resin stamper injection molding die comprising a fixed side template comprising a metal stamper mounting surface mirror-polished in a random direction, a metal stamper comprising a first main surface with a recess and protrusion shape and a second main surface on the opposite side of the first main surface, and is mirror-polished in a random direction, the metal stamper comprising the second main surface in contact with the metal stamper mounting surface, and a movable side template opposite to the fixed side template via the metal stamper, the die being used for injection-molding the resin stamper,
wherein the metal stamper comprises a surface roughness of 0 to 50 nm, and
the metal stamper mounting surface comprises a surface roughness of 0 to 1.0 nm, and comprises a coefficient of static friction of at most 0.20 with respect to the second main surface of the metal stamper.

2. The resin stamper molding die of claim 1, wherein the metal stamper mounting surface further comprises a diamond-like carbon protective layer.

3. A method for manufacturing a resin stamper applied when a recess and protrusion pattern comprising discrete tracks is transferred to an ultraviolet-curable resin used as a mask to form the discrete tracks on a surface of a magnetic recording layer, the method comprising:
injection-molding the resin stamper using a resin stamper injection molding die comprising a fixed side template comprising a metal stamper mounting surface, a metal stamper comprising a first main surface with a recess and protrusion shape and a second main surface on the opposite side of the first main surface and mirror-polished in a random direction, the metal stamper comprising the second main surface in contact with the metal stamper mounting surface, and a movable side template opposite to the fixed side template with regards to the metal stamper, the injection-molding comprises:
injecting an injection molding resin material into a cavity between the metal stamper and the movable side template; and
pressurizing and cooling the injection molding resin material;
wherein the metal stamper comprises a surface roughness of 0 to 50 nm; and
the metal stamper mounting surface comprises a surface roughness of 0 to 1.0 nm, and comprises a coefficient of static friction of at most 0.20 with respect to the second main surface of the metal stamper.

4. The method for manufacturing the resin stamper of claim 3, wherein the metal stamper mounting surface further comprises a diamond-like carbon protective layer.
